(19) United States
(12) Patent Application Publication
(10) Pub. No.: US 2013/0272221 A1
(43) Pub. Date: Oct. 17, 2013

(54) Methods and Devices for Exchanging Data in a Communications Network

(71) Applicants: Hans Thomas Hoehne, Helsinki (FI); Thomas Chapman, Stockholm (SE); Przemyslaw Czerepinski, Bristol (GB); Harri Kalevi Holma, Helsinki (FI); Antti Anton Toskala, Espoo (FI)

(72) Inventors: Hans Thomas Hoehne, Helsinki (FI); Thomas Chapman, Stockholm (SE); Przemyslaw Czerepinski, Bristol (GB); Harri Kalevi Holma, Helsinki (FI); Antti Anton Toskala, Espoo (FI)

(73) Assignee: Nokia Siemens Networks Oy, Espoo (FI)

(21) Appl. No.: 13/816,316

(22) PCT Filed: Jun. 20, 2011
(86) PCT No.: PCT/EP2011/060178

§ 371 Date: Jun. 24, 2013

(30) Foreign Application Priority Data
Aug. 12, 2010 (EP) PCT/EP2010/004949

(51) Int. Cl. H04W 72/04

(52) U.S. Cl. CPC H04W 72/04
USPC 370/329

(57) ABSTRACT

Methods and devices for exchanging data in a communications network. The present invention refers to a method of exchanging data in a communications network, the method including establishing a plurality of connections between a network device and a mobile station; splitting a flow of data from a data source into a plurality of data flows corresponding to a number of said connections; and transmitting each of said plurality of data flows over a different one of said connections. The present invention further refers to a network device and a mobile station involved in the disclosed method.

### FIELD OF THE INVENTION

The present invention relates to methods and devices for exchanging data in a communications network. Particularly, the present invention refers to a method of exchanging data in a communications network, a network device for exchanging data with a mobile station, and a mobile station for exchanging data in a communications network.

### BACKGROUND OF THE INVENTION

The invention involves at least two access points (e.g. cells) to at least one receiver (e.g. a UE). In the following, the terminology “cell” or “NodeB” and “UE” will be used. The cooperative mode of transmission is referred to as CoMP, and a UE receiving from multiple cells as a CoMP UE. The set of cells able to transmit to the same CoMP UE is referred to as the cooperating set (coop set).

Cell edge users often suffer from higher path loss and increased inter-cell interference, limiting their battery life and achievable throughput and user satisfaction. Solutions have been proposed that often are very complex from the network point of view, due to the amount of inter-nodeB synchronization required, for instance. The present invention aims at increasing data rates for cell edge users while keeping network complexity to a minimum. It is aimed at users with bursty traffic or rate-limited streaming traffic.

Another challenge is the handover process which causes UE to be instantaneously not connected to the best servicer. There is a need to have some hysteresis in order to avoid ping-pong handovers. The hysteresis may be 1-2 dB and that increases other cell interference. Another reason is the delay in the handovers caused by the measurement averaging.

WCDMA Release 99 uses macro diversity (soft handover) where the same data is transmitted from several (up to 6) NodeBs to one UE. The downlink transmissions are synchronized with an accuracy of 256 chips which allows UE to make maximal ratio combining of the signals. The WCDMA transmissions are synchronized from RNC. The same solution is not possible in HSPA since NodeB is responsible for the scheduling and RNC cannot control the scheduling.

HSDPA does not use soft handover but HSUPA still uses soft handover. Therefore, there is already a concept of active set also for HSDPA/HSUPA users which can be utilized also for HSDPA cooperative multipoint (CoMP).

Scheduling multiple HSDPA streams to a UE is part of dual carrier HSDPA, however in that case the streams are scheduled from the same Node B.

Thus, there is still a need for improved methods and devices for exchanging data in a communications network.

### SUMMARY OF THE INVENTION

Object of the present invention is to provide improved methods and devices for exchanging data in a communications network, which overcome the above mentioned problems.

This object is achieved by a method comprising features according to claim 1, a network device comprising features according to claim 5, and a mobile station comprising features according to claim 7.

Further embodiments of the present invention are provided with the corresponding dependent claims.

The object of the present invention is achieved by a method of exchanging data in a communications network, the method comprising:
establishing a plurality of connections between a network device and a mobile station;
splitting a flow of data from a data source into a plurality of data flows corresponding to a number of said connections; and
transmitting each of said plurality of data flows over a different one of said connections.

According to embodiments of the present invention, the method further comprises scheduling each of said pluralities of data flows over a corresponding data carrier.

According to embodiments of the present invention, said plurality of data flows comprise equal data.

According to embodiments of the present invention, said plurality of data flows comprise different data.

The object of the present invention is also achieved by a network device for exchanging data with a mobile station in a communications network, the network device comprising
a receiver configured to receive a flow of data from a data source;
a control module configured to establish a plurality of connections between the network device and the mobile station and to split the data flow into a plurality of data flows corresponding to a number of said connections; and
a transmitter configured to transmit each of said plurality of data flows to the mobile station over a different one of said connections.

According to embodiments of the present invention, the network device further comprises a scheduler configured to schedule each of said plurality of data flows over a corresponding data carrier.

The object of the present invention is also achieved by a mobile station, comprising a receiver configured to receive each of a plurality of data flows from a network device of a communications network over a different one of a plurality of connections established between the mobile station and the network device.

### BRIEF DESCRIPTION OF THE DRAWINGS

The present invention will be more clearly understood from the following description of the preferred embodiments of the invention read in conjunction with the attached drawings, in which:

FIG. 1 shows a multi-flow setup according to some embodiments of the present invention;

FIG. 2 shows a reception and data combining at the UE for multi-flow according to some embodiments of the present invention;

FIG. 3 shows a multi-flow setup according to some embodiments of the present invention;

FIG. 4 shows a signalling of data/pilot offsets according to some embodiments of the present invention;

FIG. 5 shows a channel estimate according to some embodiments of the present invention;

FIG. 6 shows a setup according to some embodiments of the present invention;

FIG. 7 shows a setup according to some embodiments of the present invention;

FIG. 8 shows a terminal receiver according to some embodiments of the present invention;

FIG. 9 shows an example for single site TxAA;

FIG. 10 shows an embodiment of the present invention;

FIG. 11 shows and embodiment of the present invention;

FIG. 12 shows and embodiment of the present invention; and

FIG. 13 shows and embodiment of the present invention.

### DESCRIPTION OF THE PREFERRED EMBODIMENTS

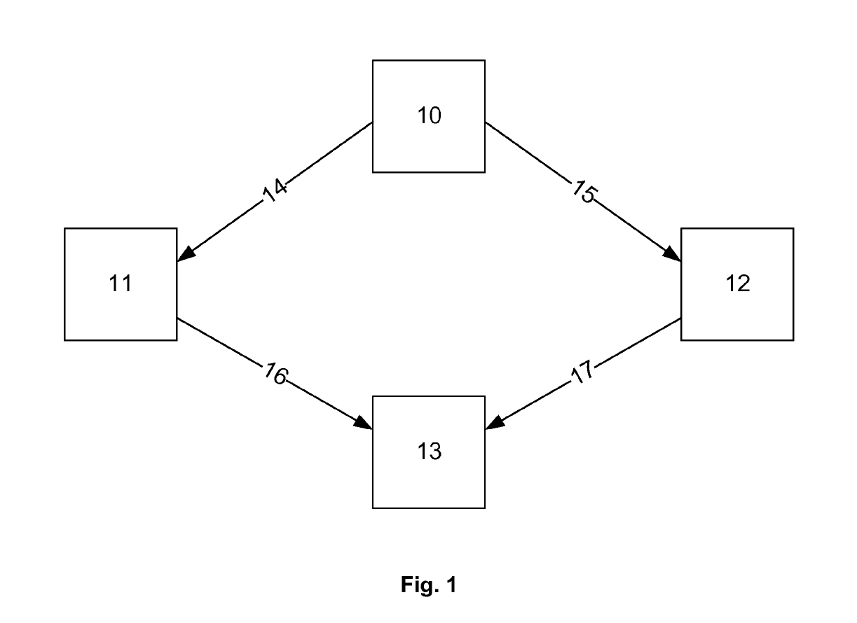

FIG. 1 shows a multi-flow setup according to some embodiments of the present invention.

In particular, FIG. 1 shows an RNC 10, distributing two separate data flows 14, 15. The two separate data flows 14, 15 are routed by two nodeBs 11, 12 in this embodiment, and arrive parallel in time as parallel data stream 16, 17 at the UE 13. The UE 13 will demultiplex the user data packets comprised in the parallel data stream 16, 17.

As shown in FIG. 1, separate data flow streams are transmitted. User data packets are multiplexed in transmission from separate nodeBs to the UE. The user data packets are transmitted with separate HARQ processes from separate nodeBs.

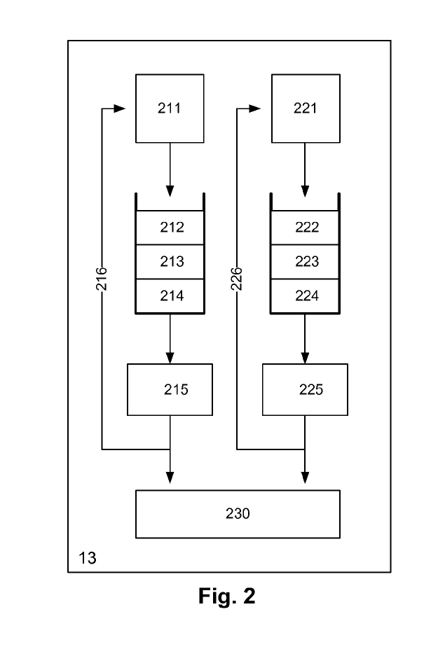

FIG. 2 shows reception and data combining at the UE for multi-flow.

In the scenario shown in FIG. 2, the UE 13 receives two parallel data streams 16, 17, i.e. two flows. In demodulation steps 211, 221, the two data streams are demodulated. The user data packets belong to separate HARQ processes 212, 222, 213, 223, 214, 224, transmitted from separate nodeBs. In decoding steps 215, 225, the two data streams are decoded by the UE 13.

According to the embodiment shown in FIG. 2, interference cancellation (IFC) 216, 226 is performed only separately, but it is well possible to incorporate cross-flow IFC. In this example, flows were split and distributed by the RNC 10 so that combining 230 happens at the UE 13 at the MAC or RLC layer. In other technologies the user data might split and combining might happen at the application layer.

According to further embodiments of the invention, UE complexity limitation in demodulation is applied. The number r of nodeBs transmitting in parallel to the UE will not exceed the capability of the UE to receive, demodulate, and equalize r nodeB transmissions in parallel. However, the number of nodeBs in the cooperating set may be bigger than r.

According to further embodiments of the invention, UE complexity limitation in decoding is applied. UE complexity can be limited by limiting the aggregate data rate from multiple NodeBs not to be higher than UE decoding capability. If UE has e.g. 42 Mbps capability and it receives data from two NodeBs, the instantaneous data rate from single NodeB is limited to 21 Mbps. That will not have any impact to the practical performance since the data rates at the cell edge are anyway lower due to other cell interference. Other splits are of course also possible, also among more than two cooperating nodeBs.

According to further embodiments of the invention, UE complexity limitation means are applied. The UE may signal inability to receive in the next TTI directly using a busy bit or implicitly by other means. The busy bit may be instrumental in achieving an aggregate data rate limit, or in avoiding reception from too many nodeBs in parallel. Both cases aim at allowing limiting the UE implementation complexity.

According to further embodiments of the invention, interference cancellation (IFC) is applied. The UE performs IFC for the signals arriving from the cooperating nodeBs. The signals are known at the UE, and the signals from the cooperating set will be the strongest interferers, thus enabling good performance gains for IFC.

According to further embodiments of the invention, DL/UL coordination is applied. The downlink multi-flow can be used at the same time as uplink HSUPA uses soft handover, or the downlink multi-flow can be independent.

According to further embodiments of the invention, the complexity at the UE 13 may be limited by an aggregate data rate limit, and/or by a maximum number of simultaneous demodulated/equalized nodeBs. Aggregate data rate limit and maximum parallel demodulation can be enforced by the UE 13 for instance by the use of a busy bit.

The aggregate data limit may be implemented to evenly limit all cooperating nodeBs' transmissions, or to selectively limit some nodeBs' transmissions.

The data rate limit can be set to e.g. the rate that a cell-center user is able to handle. Thus the decoding complexity will be given mostly by those IFC algorithms, and by parallel HARQ buffers.

According to some embodiments of the invention, the UE 13 maintains independent control channels to the nodeBs in the cooperative (coop) set. The control channels may be implemented as orthogonal codes under the same UL scrambling code.

A likely scenario for the proposed invention is that the UE realizes that it may be able to maintain several flows in parallel to a number of nodeBs. Then the RNC assesses other parameters as cell load whether all nodeBs the UE indicated or additional ones qualify for a coop set. After the coop set is decided the RNC informs the UE (through the serving nodeB), and starts distributing data to the coop set. The nodeBs are then responsible independently for relaying the data to the UE using own HARQ processes.

The RNC distributes application layer packets to the cooperating nodeBs. Application layer packets may be UDP or RTP packets.

According to some embodiments of the invention, nodeBs are responsible for their own HARQ scheduling. The RNC needs to schedule user data packets to the nodeBs. The smallest dispatch unit may be application layer PDUs, or some smaller unit, or may be created in an adaptation layer. That layer obviously would need to exist at both, nodeB and UE.

RNC scheduling may follow QoS-, expected coop-set lifetime, and load balancing criteria.

There might be situations in which the UE maintains connections to more nodeBs than its maximal parallel decoding capability. As an example, the UE is connected to three nodeBs while being able to decode flows from two nodeBs in parallel. To be able to handle such a situation, according to some embodiments of the invention a mechanism is provided to avoid having more nodeBs than the maximal parallel decoding capability of the UE transmitting at the same time. The mechanism may be such that the UE sends one “busy bit” on its UL control channel, indicating whether it is able to receive from the nodeB in the next n TTIs (n>=1) or not.

Alternatively, some indirect form of signaling may be used, such as implying absence of certain UL control elements the inability to receive in DL in the next TTI. The nodeB may still decide independently whether to transmit or not in case the UE is not busy.

A typical scenario for applying the invention is, e.g., a scenario in which data to be transmitted to the UE is either not time critical, or can be dropped without triggering higher-layer re-transmissions.

Another typical scenario for applying the invention is, e.g., a scenario in which bursty data is to be transmitted to the UE, for which the invention provides a fast form of load control/flow control.

For bursty data, the gain mechanism is similar to that of dual carrier, as unused network resources can be quickly concentrated on downloading to a UE in order to enhance instantaneous burst throughput and user experience.

The invention can also be applied for the softer handover case between sectors.

The invention has several advantages. One advantage is multi-site transmission with low network implementation complexity.

Another advantage of the invention lies in its backwards compatibility to HARQ timings of previous releases.

Interference cancellation algorithms may further improve the performance at the UE. IFC is very well suited for this kind of application, as the strongest interferers will be data flows owned by the UE and therefore are known in content.

The deployment of spatially separated transmitters 11, 12, comes with the need to correct for different Doppler shift in the UE, a functionality that is a priori not necessary in a dual carrier UE receiver. For inter-site multiflow deployment one needs to also consider that different cells may have a slight frequency offset. Then, a multi-flow capable UE should have independent frequency correction circuits, or the network has sufficient frequency synchronization and cooperative transmissions are enabled only for stationary users, a reasonable assumption.

For non-synchronized TTIs or inter-site operation one may also consider sector-independent ACK/CQI signaling to be carried on a different channel under the UE's same scrambling. The drawback of worse peak transmission power could be mitigated by intelligent scheduling or adapted UL signaling timing requirements.

An important advantage of multiflow is its ability to operate in an inter-site setting due to its lack of coordination requirements. Nevertheless, adding some degree of non-binding coordination can improve performance: Consider that the source data is available on both flows at the same time, but that the sector schedulers may act independently. In low load, a scheduler is likely to transmit immediately, whereas in high load with the presence of more users to choose from the channel state becomes more decisive for the transmission time. That means that in low load, transmissions are likely to happen at the same time, whereas in high load less so.

Therefore, for multiflow UEs without interference rejection, one may want to de-sync transmissions to the UE in low load. For multiflow UEs with interference rejection receivers, one may want to synchronize transmissions to that UE.

For intra-site multiflow the scheduling coordination can be implemented by a combined site-scheduler which is aware of the effects of interference for simultaneous transmissions, and the site-global achievable data rates. For inter-site multiflow scheduling coordination however most likely require some UE-nodeB signaling. It should be noted however that the freedom of the sector scheduler not necessarily needs to be limited, because any signaling may be interpreted only as recommendations to the scheduler.

When a multiflow UE moves out of the range of one of the sectors that it was receiving from, the packets that are still in the sector's queues are lost. The packets' retransmission needs to be initiated depending on where the data flow has been split (MAC-hs or PDCP). The retransmissions may be triggered in the traditional way, by waiting for a time out/RLC retransmission, or pro-actively if the loss of the link is detected earlier. A new message may be devised here.

The UE is constantly updating the list of its strongest potential sectors. Then, a UE may also want to signal the event where one link becomes sufficiently better than another to warrant a switch in flows.

The above described embodiments of the invention are based on at least two data flows transmitted to the UE, with the network splitting the data into several independent data flows between several cells and one UE, using the cell's native scrambling codes. The network is splitting the data at the nodeB or RNC into several flows, and while the common data source for those flows means that the flows will be transmitted at roughly the same time, the involved cells have maximal freedom in scheduling the data. In fact, the cells may act completely independently and may be ignorant of each other.

In the following, embodiments of the invention will be described for Single-frequency networks (SFN).

In UTRA DL, different cells are distinguished by a different scrambling code. Further, with HSDPA, a terminal receives data from a single NodeB. According to the invention, transmission to the terminal from at least two cells is done in a synchronized manner. When this happens, all cooperating cells transmit the HSDPA data channel, HS-PDSCH, under the same scrambling code, while transmitting other physical channels under the cells' individual scrambling codes. The transmissions from multiple cells are combined in the terminal.

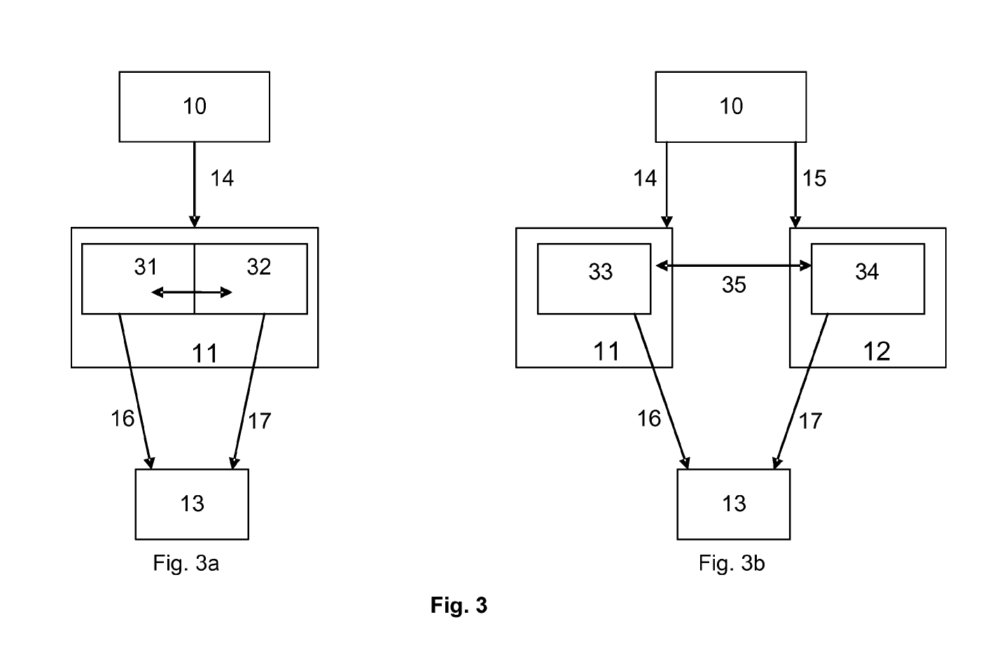

FIG. 3 shows a multi-flow setup according to some embodiments of the present invention.

In the scenario shown in FIG. 3, concurrent HSDPA transmissions 16, 17 from multiple cells 31, 32, 33, 34 to at least one HSDPA CoMP UE 13 are performed. Data 14, 15 are passed to the cooperating cells 31, 32, 33, 34 from a control entity 10, such as the RNC. The cells 31, 32, 33, 34 may be under the control of the same NodeB 11, as shown in FIG. 3a, or under the control of different Node Bs 11, 12, as shown in FIG. 3b. The cells 31, 32, 33, 34 do not necessarily need to be synchronized, however cooperating transmissions have to be synchronized, i.e., the TTIs of the cooperating cells need to be aligned. Mandating TTI synchronization of same data transmission also means that scheduling of the transmission is happening in both cells at the same time. The scheduling 35 is coordinated between the example cells 31, 32, and 33, 34, to ensure concurrent HSDPA transmissions from different cells.

One of the cooperating cells, e.g. Cell 31 (respectively e.g. Cell 33) in the examples in FIG. 3 is the serving cell. The serving cell 31, 33 transmits the data and pilot channels under a scrambling code SCA. Under current UTRA operation, SCA is not available in other cells 32 or 34; such usage is actively avoided through cell planning. With the present invention, the cooperating cells 32 and 34 are allowed to transmit the data and, as an optional extension, the pilot channel under SCA to enable SFN-type combining in the terminal. The data transmitted by cells 32 and 34 under scrambling code SCA are time-aligned with the data transmitted by cells 31 and 33.

The non-serving cooperating cells 32, 34 continue transmitting the pilot channel and other signaling and possibly data channels under their native scrambling codes during CoMP transmissions.

As an extension, the cooperating cells 32, 34 may apply complex antenna weights, thereby implementing beamforming from distributed antennas. The antenna weights may be recommended by the UE 13, and the NodeBs 11, 12 may also signal the weights applied to the terminal.

In the following, some of the main aspects of the invention regarding CoMP transmission are discussed from the network point of view:
Synchronize the network such that HS-PDSCH transmissions from cooperating cells to a CoMP UE occur at the same time.
Route the HSDPA data from the RNC to a multiplicity of NodeBs. For intra-site HS-SFN the data is made available to all sectors.
Co-ordinate the HSDPA scheduling from cooperating cells.
Schedule the HSDPA transmission from the serving cell.
Transmit the HS-PDSCH from at least two cooperating cells to a CoMP terminal. One of the cooperating cells, the serving cell, transmits all its data, including HS-PDSCH under SCA. The remaining cooperating cells transmit only the HS-PDSCH under SCA and the remaining physical channels (including the pilot channel) under a different cell-specific SC.

In the following, some of the main aspects of the invention regarding CoMP transmission are discussed from the UE, or terminal, point of view:
HS-PDSCH transmissions from cooperating cells combine “over the air”, as they are transmitted under the same scrambling code.
The propagation channel, experienced by HS-PDSCH, as seen at the terminal, is a superposition of the multiple propagation channels.
The superposition of the propagation channels must be re-created by estimating each channel separately (from the respective pilot) and then adding up the individual impulse responses.
An additional weighting of the impulse responses is required if the pilot/data power ratio is different in the cooperating cells.

According to some embodiments of the invention, some flow control may be required on network side, e.g. at the RNC, to ensure that bursts are fully delivered in case a cooperating nodeB drops out of the cooperating set before a burst has been delivered in full. In the basic form of this approach no inter-nodeB signaling is required. In case of a busy-bit feature (see below), the nodeB must be able to delay transmissions.

According to some embodiments of the invention, in downlink several nodeBs transmit separate (HARQ) transmissions towards at least one UE. The nodeBs are independent in their transmissions.

According to further embodiments of the invention, the entity (e.g. the RNC in an HSPA network) which distributes the data flows to the cooperating nodeBs, may take into account at least one of the following:
Average throughput achieved from the Node B in question to the UE
Other load on the Node B (e.g. if one of the Node Bs has a download to another UE)
Relative path losses to the UE
Uplink load at each Node B (For HSPA the additional HS-DPCCH signaling will cause UL overhead)

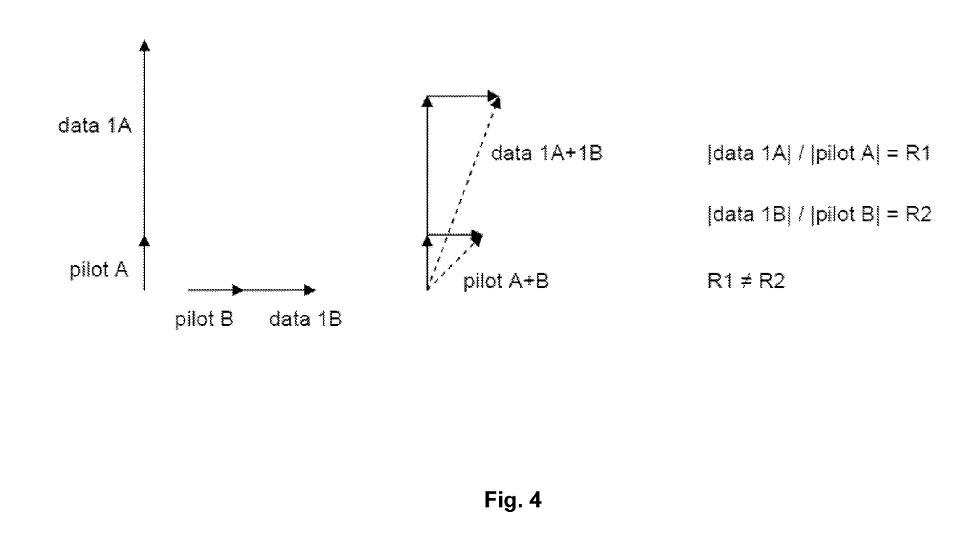

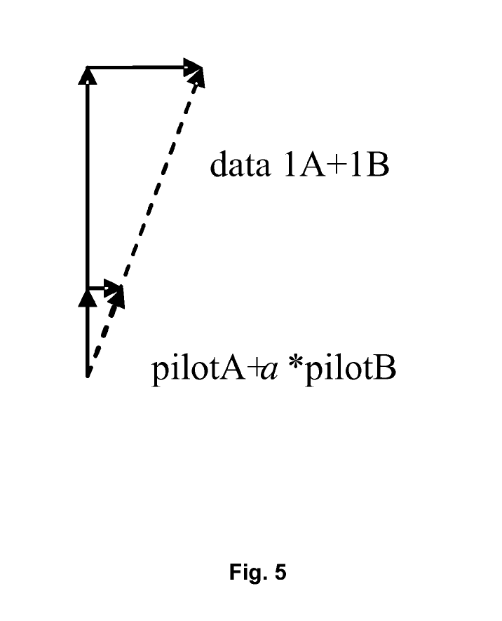

FIG. 4 shows a signalling of data/pilot offsets according to some embodiments of the present invention, and FIG. 5 shows a channel estimate, formed based on weighted pilots, Both described in more detail in the following.

Data to pilot ratios may vary in different cooperating cells, for example because non-serving cooperating cells may have to reserve some power to overcome the intracellular interference injected by the use of SCA. In such a case, the superposition of channel impulse responses is not the correct reference for demodulating the HSDPA data channel, as illustrated in FIG. 4. To address this, additional signalling will need to be provided to the terminal so that the necessary adjustment can be made according to the following equation, as illustrated in FIG. 5:

$$\frac{α \vert pilot B \vert}{\vert pilot A \vert} = \frac{\vert data 1 B \vert}{\vert data 1 A \vert}$$

This can be realized in a number of ways, of which two examples are provided below:

### EXAMPLE 1

Signal the parameter α, equal to:

$$α = \frac{\vert data 1 B \vert}{\vert data 1 A \vert} \frac{\vert pilot A \vert}{\vert pilot B \vert}$$

### EXAMPLE 2

For each cooperating cell, signal the ratio:

$$\frac{\vert pilot 1 x \vert}{\vert data 1 x \vert}$$

It will be clear to those skilled in the art that other forms of signalling can be conceived to achieve the same goal and that the signalling can be extended to a set of three or more cooperating cells. Furthermore, we have described a weighting of the pilots; it is clear that the same effect can be achieved through a weighting of the data, the channel impulse responses or a hybrid. Also signaling may be avoided by using a fixed alpha that is not posing any interference problems, and is known to all CoMP UEs by convention.

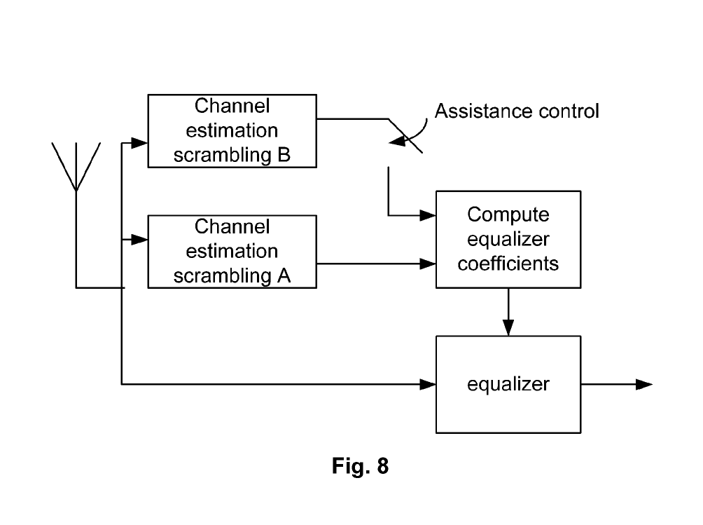

FIG. 8 shows a terminal receiver according to some embodiments of the invention.

The channel estimate which is used to derive the equalizer coefficients is based on the pilots. For an assisted transmission, the data which is input to the equalizer is a superposition of two signals that have experienced two different channels. Hence both channels need to be estimated, the channel of the assistive transmission from the pilot of cell B. Only the combined channel estimate is then used to derive the equalizer coefficients, while the equalizer operation and all subsequent decoding essentially remains the same.

By having the assisting cell transmit with less power on its own scrambling code (scrambling B) and more power on the “foreign” scrambling (scrambling A), the interference scenario is changed with respect to normal network operation.

According to embodiments of the invention, as an extension, the cooperating cells may apply complex antenna weights, thereby implementing beamforming from distributed antennas. The antenna weights may be recommended by the UE. The NodeBs may also signal the weights applied to the terminal in order to limit error cases due to the UE hypothesizing an incorrect weight or set of weights.

According to further embodiments of the invention, as another extension, the pilot can be included in the transmissions from non-serving cells. In this case, both the pilot and the data will combine “over the air” and the terminal has only a single channel impulse response to estimate. The data/pilot amplitude ratios must be the same in all cells where the extension is applied.

All cooperating cells use the same set of HS-PDSCH codes (same OVSF code space) and transmit using the same MCS and RV. The CoMP transmissions are synchronized.

Advantages of the current invention comprise:
An energy gain, as the same data are now transmitted from two or more sites.
An interference reduction, as the cooperating sites no-longer present intercellular interference to one another
A diversity gain, as signals from different cooperating cells would experience different propagation conditions.
In the case of extension to TxAA, the beamforming gain is achieved through coherent combining of the data channels.
In the case of extension to transmitting Pilot A from non-serving cells, terminal complexity can be reduced.
The method described is expected to be of most value in the case of bursty traffic, where neighboring cells are likely to have spare power resource available.

Only the HSDPA data channel, or the HSDPA data channel plus pilot, are placed under SC_{A} in a cooperating non-serving cell (during a CoMP transmission). The cooperating non-serving cell continues to transmit the pilot and signalling channels under the native SC; therefore, it is possible for non-CoMP UEs to remain synchronized to such a cell.

An alternative implementation may be one in which a third scrambling code, SC_{C} is used for CoMP transmissions. In this case, all cooperating cells would transmit data using SC_{C}, whilst transmitting pilots and other signalling using their own cell specific scrambling codes,

A further extension of the technique would be one in which the cooperating base stations each possess their own beamforming arrays and each steer their beams towards the target CoMP UE.

According to some embodiments of the invention, a UE which is in the cell which is making a CoMP transmission on another scrambling code will measure higher interference in the particular TTI. The UE will therefore report lower CQIs, but the nodeB may also offset the UEs reported CQIs in its downlink transmissions by a value that it deems appropriate. One problem here is that the UE is may filter its measurements over >3 slots before reporting a CQI, and the nodeB cannot apply a perfect inverse filter to the UE's reports. On the other hand, given the knowledge of actual interference in its site, and given the history of past UE CQI reports and corresponding BLER the nodeB may be able to make educated guesses in what way a UE's reports should be interpreted.

It is worthwhile to note that the amount of interference that the UE measures will be affected by its relative location in the cell, and a UE close to the cell center will report high interference in a TTI of assistive transmission. Therefore the nodeB should take into account the UE's location when adjusting its reports for TTIs of assistive transmissions.

In case of two consecutive TTIs in the assisting cell, one of CoMP transmission followed by one non-CoMP transmission, as the HS-SCCH is preceding the HS-PDSCH by two slots, in the TTI of CoMP transmission the HS-SCCH will be subjected to higher interference. The power used for the HS-SCCH is implementation dependent, and is set to allow users to still reliably receive their control information. To maintain the same SINR for the HS-SCCH, its power will have to be increased in the assisting TTI. Cell-edge users will require a higher increase than cell-center users.

Other control channels that are “always on” are the BCH, and PCH/FACH. Further, cells that operate HSDPA simultaneously with Rel 99 DCH require the DCH, and DL DPCCH channels for UL users. In case of no Rel 99 channels the multiple DL DPCCHs could be replaced by one F-DPCCH. Last, for HSUPA the E-HICH in DL carries ACK for UL transmissions. Also the E-RGCH/E-AGCH cannot be switched off. However unlike any other of the control channels this one can be scheduled to avoid TTIs of CoMP transmission.

According to further embodiments of the present invention, all control channels are kept on the anchor carrier, whereas HS-SFN transmissions take place on the secondary to avoid interference for control channels for Dual (or higher) Carrier systems:

Above interference considerations also hold in the presence of a third interferer of equal strength.

The assumption that cells are TTI aligned is also of importance to the transmit power budget at the assisting cell, because one would not want to exceed the normal operation power budget by transmitting assistive HS-PDSCH superimposed with normal (own) HS-PDSCH.

Some networks may want to de-synchronize the cells of a site by a constant delay of a multiple of 256 chips, so as to avoid overlapping SCH among the cells and help acquisition of the S-SCH. As the SCH has a fixed timing relation to the other channels, this would mean that parts of the CoMP transmission would start overlapping with the cell's own HS-PDSCH. A possible remedy is to have no assistance in the overlap areas. Also consecutive TTIs of assistance would again mitigate the effect.

Yet the problem is avoided if adjacent cells are not relatively delayed by a multiple of 256 chips. Then P-SCH acquisition would be helped, but S-SCH acquisition might take longer.

A part of the gains of CoMP single frequency transmission will rely on exploiting the fast fading of the links, and providing up-to-date channel state information and dynamic scheduling based on the channel reports will be needed.

Therefore, according to some embodiments of the invention the nodeB may decide whether to do CoMP transmissions on a TTI-to-TTI basis. To do so, the CoMP UE could report the channel quality information not only of the serving BS, but also of the next strongest BS which is able to provide assistance.

According to further embodiments of the present invention, alternatively, the UE could report 2 CQIs; one of which would assume no CoMP assistance and the other a CoMP transmission. The reporting may follow similar procedures as the reporting in the case of DC-HSDPA UEs.

The nodeB also needs to inform the UE that it is about to receive a CoMP transmission. Only then the UE is able to derive the correct equalizer coefficients by combining the impulse responses that it measured from the two cells.

Further there must not be any ambiguity in which of the neighbor cells is giving assistance, a problem that is best tackled by avoiding any ambiguity about whose neighbor's channel states the CoMP UE had been reporting. Recall now that a UE is reporting signal strength of cells to the RNC using measurement report messages, and even though the measurement are passing through the nodeB it does not immediately have access to that information.

Therefore, according to some embodiments of the present invention the RNC informs the nodeB about the possible set of assistive cells, and the UE includes an index into that set into its CQI reports.

According to further embodiments of the present invention, a less signaling-intensive but also less error-resistant approach would be to restrict the UE to report intra-site CQIs and let the nodeB figure out at what cell edge the UE is located. That may work well for quasi-stationary users.

According to further embodiments of the present invention, the UE is sending measurement reports about neighboring cells' RSSI not to the RNC, but to the nodeB for forwarding to the RNC, as mentioned in the section on HS-DDTx. The same measure of reliability could be achieved as with RLC transmissions, while at the same time making the nodeB aware of the measurements, without increasing signaling load.

When signals are combined over the air, arriving over two independent channels, the main paths of the channels may be coinciding in time. Then, the signals will add up for that path sometimes in constructive, sometimes in destructive manner. To avoid overlapping path with the danger of lost signal energy one may choose to adjust the timing of the assistive transmission so as to separate the main signal path to allow an equalizer to pick up all signal components. The adjustment of path components can happen using pseudo-random delays, or by explicit signaling. That approach is akin to cyclic delay diversity in OFDMA systems, with the difference that any signal shift will be non-cyclical.

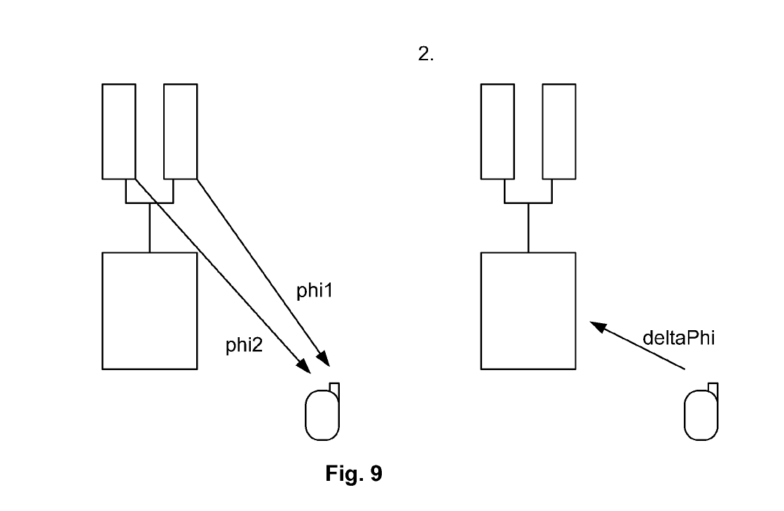

One approach for improving system capacity or coverage aimed at users in the border areas of cells is to coordinate neighboring nodeBs in their transmissions towards a particular UE or groups of UEs. Among those coordinated multipoint (CoMP) transmission schemes are multi-site TxAA schemes, which are a form of multi-site beamforming. To achieve multi-site beamforming it is necessary that the phases between the cooperating transmitters are aligned in the desired manner. In single-site beamforming this is achieved by either providing calibration circuitry at the transmitter, or using feedback schemes, which is shown in FIG. 9. Once the phases of the antennas have been aligned the antenna signals will constructively add at the UE antenna. Multipath components will be coherently added by the UE equalizer or RAKE receiver.

In a multi-site deployment, however, the short-, medium-, and long-term phase relative stability between transmitting antennas may not be as good as in the single-site case. Further, the paths of transmitting nodeBs will typically not align.

In this context, power delay profiles (PDP) will be discussed now. In the following scenarios, such PDP is assigned to a UE transmitting to two different nodeBs. In the examples chosen each nodeB has two antennas; however one may assume that each nodeB (sector) has one or more antennas.

The time shift between main paths of the cooperating nodeBs is actually desirable, because if the main paths overlap, it will be necessary to align all phasors of all nodeBs of all antennas. If the paths are separate, only the phasors specific to each nodeB need to be aligned. The receiver further then estimates each nodeBs channel response, and performs equalization coherently adding all paths of all nodeBs.

For CDMA systems, the invention proposes to make sure that the main paths of cooperating nodeBs do not overlap. This is explained in more detail in the following.

According to some embodiments of the present invention, the method for managing cooperative transmission comprises the following steps:
a) Measure the relative delays of the main signal paths of antennas of nodeBs at the UE.
b) Determine at the UE the desired delays to
   a. improve SINR at the receiver e.g. by
      i. spacing apart the main path components just far enough to be resolved by the UE receiver (i.e. equalizer in CDMA) and/or
      ii. no destructive interference takes place and/or
   b. minimal delay spread is obtained
c) Signal the UE desired delays to one or more cooperating nodeBs. The UE may combine signaling the desired delay with the desired weight vector or other feedback data.

According to further embodiments of the present invention, the relative delays of the main signal paths may be measured specific to nodeBs, or separately for all transmitting antennas of all nodeBs, or in arbitrary sets. The adjustments may happen separately, or in arbitrary sets.

In summary, according to the present invention, the basic principle is to apply a delay diversity scheme to WCDMA by applying a non cyclic shift and relying on an equalizer to remove the ISI and optimally combine the receive paths.

In the following, two exemplary implementation variants for the present invention are given.

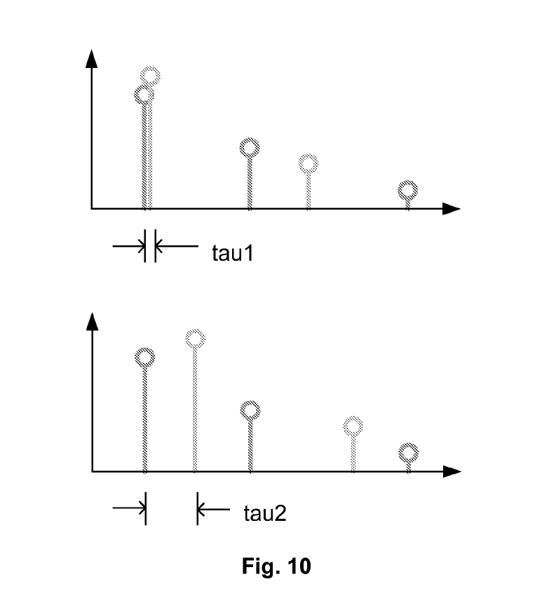

In a first implementation variant, according to some embodiments of the present invention, the UE measures the PDP of the cooperating nodeBs. It determines the desired shift between the cooperating nodeBs, e.g. based on best equalizer performance. Then it signals the desired shift to the nodeBs. As an example, as shown in FIG. 10, the UE measured a delay difference of tau1, but determined that receiver performance would be better with a difference tau2 and therefore signaled tau1-tau2 to the nodeBs.

The signaling may happen to one nodeB who distributes to the others, or it signals to each nodeB separately. Further the signaling may happen in differential form over time, as the paths may slowly change over time.

The advantage is that more paths may be resolved leading to higher SINR, or that the total delay spread may be reduced, leading to lower equalizer complexity requirements.

In a second implementation variant, according to some embodiments of the present invention, the UE measures the PDP of all coop nodeBs. It signals the PDP to the coop nodeBs. The signaling may happen as described for the first implementation variant.

The nodeBs determine which delays should be applied to their transmissions in order to achieve best reception at the UE.

It has to be noted that the speed of path changes may be estimated and extrapolated and signaled in addition to the desired delay.

The above described method can be applied for instance to WCDMA-type networks, but also to OFDMA networks where the multipath components can no longer be resolved by the cyclic prefix.

For CDMA the delay adjustment may be in the range of chips or sub-chips. For OFDMA the delay adjustments may happen within the cyclic prefix, or they may be carried out by time-delaying the OFDMA symbol by the desired amount of samples.

In the following, methods for carrying out power delay profile adjustments for cooperative transmissions will be described.

According to some embodiments of the invention, power delay profile adjustments are carried out in random- or pseudo-random fashion for assisted transmissions.

According to further embodiments of the invention, power delay profile adjustments are carried out in open loop manner: The PDP is modified in transmission while SINR or CQI reports are monitored.

According to further embodiments of the invention, delay adjustment related signaling is carried on low-power pilots added to the data. Those pilots' power will be too low for channel estimation but high enough for signaling.

According to further embodiments of the invention, for intra-site HS-SFN, a standard delay between cells is introduced to separate the main paths for the case of a line-of-sight link.

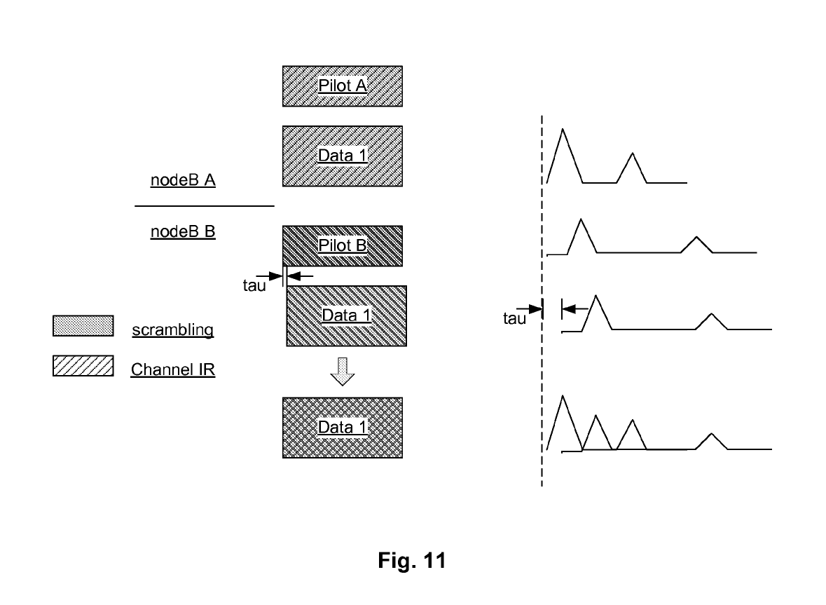

In the following, a more detailed description for methods according to embodiments of the present invention is given.
A) for pseudo-random delay adjustments (“random walk”) a typical sequence of steps might look as follows:
   I) UE-non-transparent operation
      1) the UE and the assisting cell agree on the start for a common pseudo random sequence
      2) every (n-th) TTI the assisting transmitter delays its transmission as a function of the pseudo random sequence. The assisting cell delays only the HS-DSCH, as shown in FIG. 11. It has to be noted that the orthogonality to other channels as control is not affected, as the assisting cell only transmits the data and has its own control on a different scrambling code.
      3) the HS-SFN UE estimates the channel of both cells. When combining the impulse responses (IR) for the purpose of equalizing the data it applies the inverse delay to the IR of the cooperating cell.
B) for open-loop delay adjustments a typical sequence of steps might look as follows:
   I) UE-transparent operation
      1) the cell may try various algorithms for searching the optimal delay
         a. successively try a range of delays and record what are the corresponding CQI reports
         b. adjust delays according to CQI gradients
         c. a combination of the above
   II) UE-non-transparent operation enabled with additional signaling, see C)
C) data-embedded pilots signal the timing adjustment. For DL TxAA, where the Node B adjusts the phase between 2 antennas in the same cell, the technique of transmitting a dedicated pilot and comparing its phase to the main pilot is well known. Here, the two antennas belong to different cells and it is the timing and not the phase that is offset.
   I) this method is well suited to be combined with A). That is, in scheme A) the nodeB could be using signaling of the start value of the pseudo random sequence.
   II) Earlier it was suggested that the UE signals the desired delay and it was assumed that the BS is able to correctly receive and decode the UEs message. Here, the BS may use DL signaling to acknowledge the UE's delay request.

For ACK/NACK signaling a 1-bit codeword carried on the embedded pilot is sufficient. A 1-bit signal can be used also for differentially encoded delay signaling. For differentially encoded delay signaling a starting and/or reset condition may be defined by explicit messages, or be implicitly derived from system time. Also, an n-bit codeword can be assembled at the UE over n successive TTIs. The n-bit codeword may carry e.g. delay information, but also other necessary HS-SFN control information such as whether an assisted transmission is being carried out.
D) default PDP adjustment delay for intra-site For intra-site the main path component may be always overlapping when there is a line-of-sight between the UE and the cell transmitters. Therefore a minimum constant delay of a few chips may be introduced

A.II) requires no signaling of adjustments. It requires however signaling of the beginning of a random walk, or some standardized agreement on a random walk. For instance, the random walk information may be contained in some generally known number as MS ID or system time, and be enabled for all assisted transmissions

B.I) requires no signaling. B.II) see C.I)

C.I) signaling is present in the DL in form of the delay information, or in the form of random walk start/stop information.

C.II) signaling is present in UL and DL in form of delay and acknowledgment information.

D) requires no signaling.

The concept of random walk could be also combined with open loop, and DL signaling: DL signaling indicating start/stop for the random walk.

CoMP single frequency transmission will be enabled only by fast coordination among cells, mandating intra-site operation and a site-common scheduler. Coordination for intersite operation is conceivable, but is likely to prove impractical for several reasons.

While the primary cell is receiving the HS-DPCCH, one has to assume that there is one central site-scheduler who is making decisions which cell is assisting or receiving assistance. This combined-cell-scheduler will base its decisions on the total site-gain that can be achieved as opposed to single-sector metrics.

In the absence of a combined site scheduler other intra-site scheduling schemes can be devised, e.g. where one sector acts as a master to its neighbor, but the role of master is rotated from time to time.

In the following, a method for coordination of two or more independent schedulers involved in cooperative transmission will be described.

Cooperation among cells is determined in following fashion:
neighboring cells are assigned priorities. The cell with the highest priority may request assistance from cells with lower priorities.
the priorities at a given instant in time may be assigned to the cells in the manner of a frequency reuse pattern, avoiding priority conflicts.
in a following time slice (e.g. frame or period of time) priorities are rotated in a predetermined manner or are communicated.

In the following, some exemplary implementations for the method for coordination of two or more independent schedulers according to the present invention will be proposed.

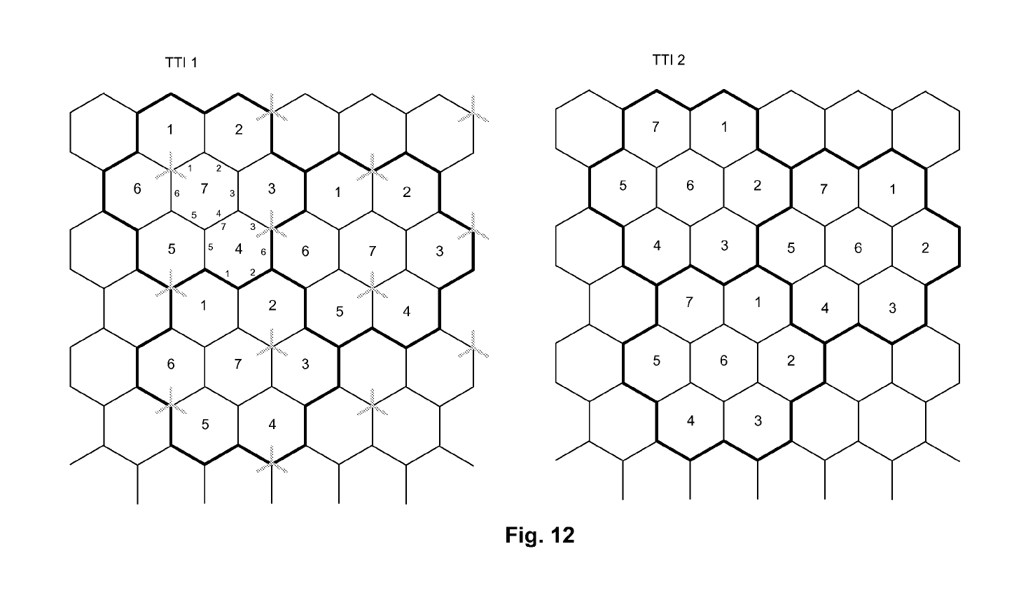

An example algorithm might look as follows:
TTI 1) (A) gets the token first (is master). If coop tx request assistance from whomever. If there is no cooperative user schedule normally. Pass the token (master role) to next BS
   Passing of token in the same TTI optional, reducing coordination load
   a BS that is no longer able to request assistance because other BS already have their TTIs scheduled may transmit to the CoMP UE without assistance.
TTI 2) priorities are reassigned (shown in FIG. 12): (B) is master. Do as above.

The priorities may be assigned to the cells such that no overlap or conflict of priorities occurs. Effectively the priorities are assigned according to a frequency-reuse pattern.

For a practical scheduler priorization of non-CoMP UEs over CoMP UEs or vice versa may be introduced.

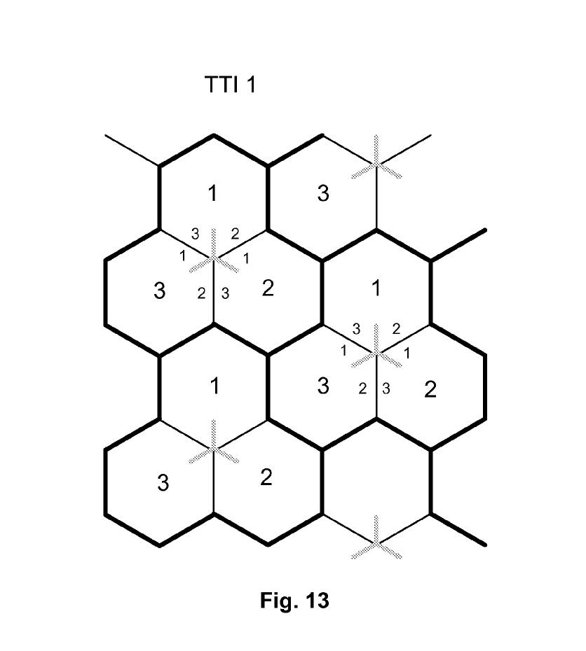

The scheme is also applicable to approaches where only intra-site cooperation is applied; see FIG. 13 showing priority rotation for priority reuse 3. Then, there are only two neighbors to coordinate with.

The scheme is applicable to any CoMP scheme requiring coordinated or even simultaneous transmissions, such as HS-SFN or multi-site TxAA for WCDMA or coordinated beam-forming in LTE.

The above described embodiments of the invention describe multi-flow data transmissions from several cells to one UE.

In the following, data-discontinuous transmissions are described. In data-discontinuous transmissions for HSDPA (HS-DDTx), interference to the UE of a sector is reduced by not scheduling any data transmissions in the sectors which would act as its strongest interferers. Embodiments of HS-DDTx can be implemented without modifications to the standard.

According to some embodiments of the invention, independent schedulers for the sectors in a site are maintained, wherein the schedulers are allowed to schedule data in a sector-round-robin fashion. Advantageously, scheduled UEs will not experience intra-site interference beyond that of the control channels that cannot be switched off.

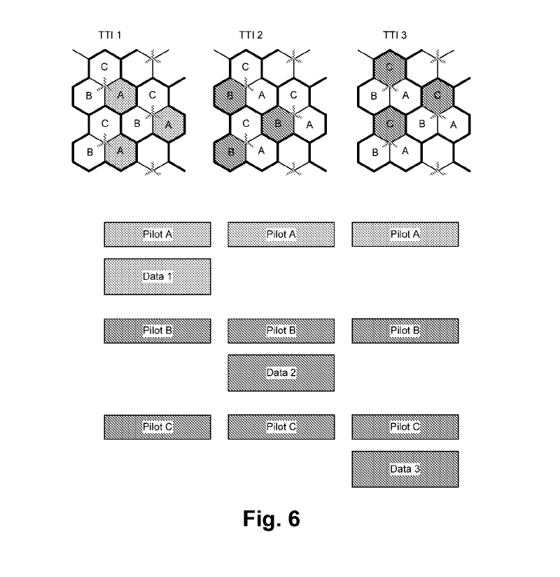

FIG. 6 shows an embodiment of the invention, wherein the token passing is synchronized to some network-wide timer then the data-channel related interference avoidance is even extended to the whole network.

For a site with >3 sectors one may enhance that scheme to have two (or more) tokens going around, while still getting almost the same effect. Of course with more advanced approaches one may include also UE location (which cell edge, if any).

This HS-DDTx approach is similar to a time-domain interference coordination scheme. The scheduler needs to be able to perform a graceful transition to high-load scenarios.

According to further embodiments of the invention, at the nodeB there is one scheduling entity that is scheduling all UEs of all sectors belonging to the same site at the same time. That combined- or common-site scheduler requires access to the UEs' reported CQIs, and actual intra-site interference information. An exemplary scheduling algorithm that considers the site-wide throughput may then look as follows:
1. compute proportional fair metrics for all sectors transmitting and select best UEs
2. compute metrics for sector 1 transmitting, but not sector 2,3, and select best UE
   a. and the same for the other sectors
3. compute metrics for sectors 1,2 transmitting, but not sector 3
   a. selecting the best UE pairs can be done using exhaustive search, but a shorter heuristic approach can be to select the strongest UEs, or the ones farthest apart in the sectors
   b. and the same for the other sectors
4. from all the options choose the one which has the highest overall metric.

Since realistically inter-site synchronisation is unlikely to be available and thus interference coordination is limited to intra-site coordination, the performance of this approach should be superior to that of a simple intra-site round robin approach.

The NodeB has knowledge of a UE's DL interferers and CQI reporting. A UE is constantly measuring the signal strength of its neighbouring sectors, in order to identify HO candidates and maintain its active set. It traditionally sends its measurement reports to the RNC on a need basis, or per request. For active data connections the UE also sends CQI reports to the nodeB, allowing the nodeB to perform fast-fading link adaptation. The calculation of a CQI is left to UE implementation and vendor- or even UE-model specific. NodeBs will typically keep track of a UE's reported CQIs and its BLER performance, and consequently apply some UE-specific link adaptation.

For “simple” interference avoidance (interferer-ignorant scheduler) as in the RR-sector scheduling, the token-passing pattern most likely is independent of the UEs relative location to their strongest interferers. The nodeB is therefore not in immediate need of the UEs' neighbour sector measurement reports.

With RR-sector scheduling, the CQI reports will be subject to periodic interference fluctuations due to the periodic activation/deactivation of HS-DSCH in neighbouring sectors, unlike without the RR-sector scheduling, in which DTX of HS-DSCH occurs when there is no user to schedule and is more likely to be randomised. Therefore, care needs to be taken at the nodeB how to interpret the CQI reports.

For interferer-aware scheduling, the nodeB may with some degree of certainty deduce what will be the actual interference situation in the intra-site case from the CQI reports, knowledge of the sectors with which the UE is in softer handover and UL signal strength measurements. However, inverse-filtering of UE's CQI reports of unknown parameters may become reliable only after sufficient amount of CQI reports have been gathered.

A better source of information for the nodeB on the relative strengths of interferes to a UE thus may be the UE measurement reports along with possible information about the UE's relative location in the sector. As mentioned above, the reports are available to the RNC, but could be forwarded (back) to the nodeB.

An interference-aware scheduling at the nodeB that seeks to evaluate also inter-site sector interference information will need to rely on measurement reports provided by the RNC.

Alternatively, UEs in the softer handover region could be required to report CQIs considering the possibility of no DTX and also with DTX.

A nodeB may also try to listen to neighbouring DL transmissions, or try to decode UL measurement reports or CQI reports of UEs in neighbouring sectors.

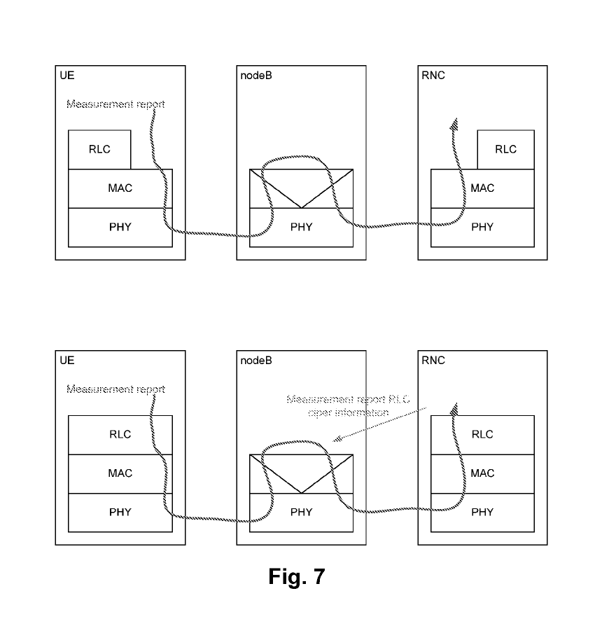

With regard to measurement reports signalling flow simplification, a possible simplification of the passing of a UE's measurement reports messages bringing reduced signalling delay and reduced signalling load would be to introduce an alternative way of forwarding measurement reports. Traditionally the UE sends the reports as RLC messages, which cannot be read by the nodeB. Instead, a HS-DDTx enabled may send its neighbour-sector strength report as MAC-message (or a message designed with suitable reliability) to the nodeB, as shown in FIG. 7. The nodeB then is able to read the contents and forward it to the RNC. That approach may be applied only to relevant measurement reports, without altering other RLC signalling methods. Note that nodeB-readable measurement reports are also desirable for other intra-site multi-sector transmission scheme, including multi-flow and HS-SFN.

In above examples TTI-aligned sectors were shown. However, HS-DDTx can also be applied to asynchronous networks. Then it may be possible to avoid the interference for only part of a TTI, with only part of the gain.

In the light of energy savings it may be also worthwhile noting that for similar channel gains avoided interference always means less used transmission power.

While embodiments and applications of this invention have been shown and described above, it should be apparent to those skilled in the art, that many more modifications (than mentioned above) are possible without departing from the inventive concept described herein. The invention, therefore, is not restricted except in the spirit of the appending claims. Therefore, it is intended that the foregoing detailed description should be regarded as illustrative rather than limiting.

### LIST OF REFERENCES

10 network device
11, 12 nodeBs
13 mobile station, UE
14, 15 data flows
16, 7 data streams
211, 221 demodulation steps
212, 222,
213, 223,
214, 224 HARQ processes
215, 225 decoding steps
216, 226 interference cancellation
230 combining
31, 32,
33, 34 cells

1. A method of exchanging data in a communications network, the method comprising:
establishing a plurality of connections between a network device and a mobile station;
splitting a flow of data from a data source into a plurality of data flows corresponding to a number of said connections; and
transmitting each of said plurality of data flows over a different one of said connections.

2. The method according to claim 1, further comprising scheduling each of said pluralities of data flows over a corresponding data carrier.

3. The method according to claim 1, wherein said plurality of data flows comprise equal data.

4. The method according to claim 1, wherein said plurality of data flows comprise different data.

5. A network device for exchanging data with a mobile station in a communications network, the network device comprising:
a receiver configured to receive a flow of data from a data source;
a control module configured to establish a plurality of connections between the network device and the mobile station and to split the data flow into a plurality of data flows corresponding to a number of said connections; and
a transmitter configured to transmit each of said plurality of data flows to the mobile station over a different one of said connections.

6. The network device according to claim 5, further comprising a scheduler configured to schedule each of said plurality of data flows over a corresponding data carrier.

7. A mobile station, comprising a receiver configured to receive each of a plurality of data flows from a network device of a communications network over a different one of a plurality of connections established between the mobile station and the network device.
